(19) United States
(12) Patent Application Publication
(10) Pub. No.: US 2012/0263101 A1
(43) Pub. Date: Oct. 18, 2012

(54) METHOD TO DE-MULTIPLEX DATA AND/OR SIGNALS FROM A SINGLE DATA CARD INTO MULTIPLE INTERFACES AND TO ALLOW PARALLEL CONNECTIVITY

(76) Inventors: Mahmoud K. Jibbe, Wichita, KS (US); Madhukar Gunjan Chakhaiyar, Bihar (IN); Dhishankar Sengupta, Bangalore (IN)

(21) Appl. No.: 13/085,683

(22) Filed: Apr. 13, 2011

(51) Int. Cl. H04W 4/00

(52) U.S. Cl. 370/328

(57) ABSTRACT

An apparatus comprising a device, a multiplexer circuit and a plurality of interface circuits. The device may be configured to present/receive a multiplexed data signal from a wireless network. The multiplexer circuit may be configured to present/receive a plurality of data signals in response to the multiplexed data signal. The plurality of interface circuits may each be configured to present/receive a respective one of the data signals. At least one of the interface circuits is a first interface type. At least one of the interface circuits is a second interface type. The apparatus may allow the plurality of interface circuits to share access to the wireless network.

### FIELD OF THE INVENTION

The present invention relates to data interfaces generally and, more particularly, to a method and/or apparatus to de-multiplex data and/or signals from a single data card into multiple interfaces and to allow parallel connectivity.

### BACKGROUND OF THE INVENTION

A Universal Serial Bus (USB) data card is typically used for a single connection. In conventional systems, the available data has a Media Access Control (MAC) identity which is used to establish communication between wireless software applications running on a personal computer (PC) via a single USB port or a single Personal Computer Memory Card International Association (PCMCIA) interface. In a scenario where multiple different connections are needed, several data cards are used. Conventional wireless cellular routers are available, but none of the routers offer multiple interface support. Also, the flexibility to choose different cellular technologies, such as Global System for Mobile Communications (GSM) and Code Division Multiple Access (CDMA), is not available in conventional products.

It would be desirable to implement a method to de-multiplex data and/or signals from a single data card into multiple interfaces to allow parallel connectivity.

### SUMMARY OF THE INVENTION

The present invention concerns an apparatus comprising a device, a multiplexer circuit and a plurality of interface circuits. The device may be configured to present/receive a multiplexed data signal from a wireless network. The multiplexer circuit may be configured to present/receive a plurality of data signals in response to the multiplexed data signal. The plurality of interface circuits may each be configured to present/receive a respective one of the data signals. At least one of the interface circuits is a first interface type. At least one of the interface circuits is a second interface type. The apparatus may allow the plurality of interface circuits to share access to the wireless network.

The objects, features and advantages of the present invention include providing a method to de-multiplex data and/or signals from a single data card into multiple interfaces that may (i) allow parallel connectivity, (ii) support multiple interfaces (e.g., USB, PCMCIA, RJ45, Serial Port, Wireless Access Point, etc.), (iii) change an input data card based on user preferences with a particular carrier, (iv) support GSM and CDMA technologies, (v) set priority to enhance data/signal streaming on any of the interface, (vi) enable operation in the absence of an external power supply by implementing onboard battery power, (vii) reduce cost by providing a single connection device configured for a number of interfaces, (viii) establish communication between an end device (e.g., personal computer) and a data card during a channel failure, (ix) quickly establish a portable work station with access to the Internet, (x) provide multiple user interfaces configured to function simultaneously, (xi) maintain signal strength across all interfaces using a crystal oscillator and a frequency synchronizer, (xii) provide the same signal strength (e.g., the signal strength of an input data card) to each end device, (xiii) allow end users to choose a preferred carrier and/or (xiv) prioritize data/signal streaming on any type of interface.

### BRIEF DESCRIPTION OF THE DRAWINGS

These and other objects, features and advantages of the present invention will be apparent from the following detailed description and the appended claims and drawings in which:

FIG. 1 is a block diagram of a hardware device;

FIG. 2 is a more detailed block diagram of the hardware device;

FIG. 3 is a diagram illustrating assignment of priority to multiple channels;

FIG. 4 is a diagram illustrating upstream and downstream data flow;

FIG. 5 is a diagram illustrating a process of streaming signals; and

FIG. 6 is a diagram illustrating a process of streaming signals.

### DETAILED DESCRIPTION OF THE PREFERRED EMBODIMENTS

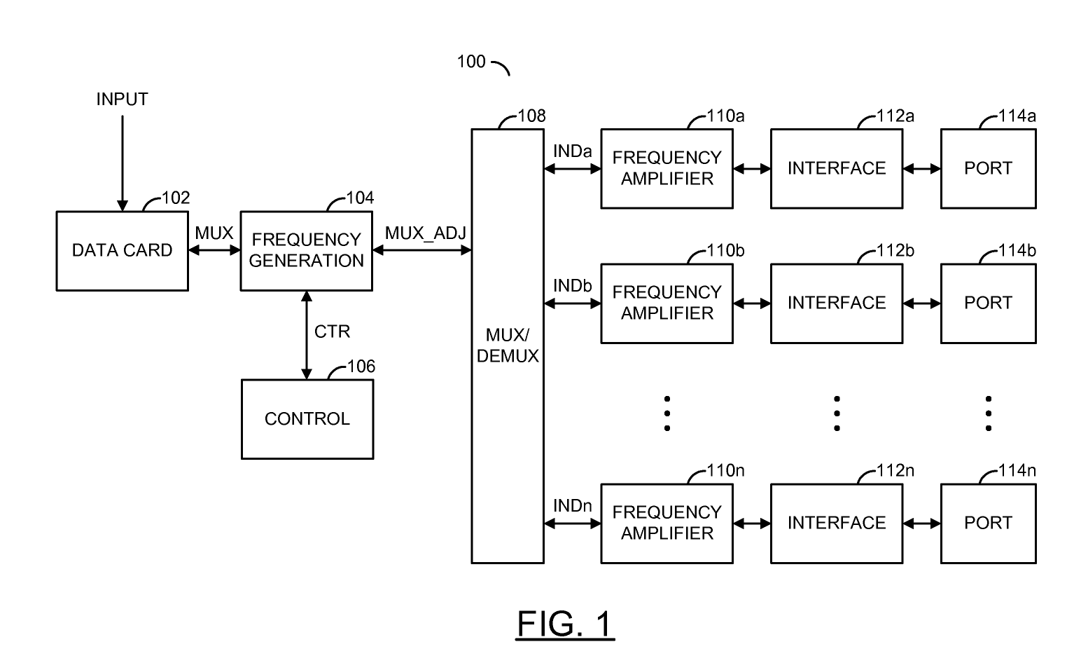

Referring to FIG. 1, a block diagram of a system 100 is shown in accordance with a preferred embodiment of the present invention. The system 100 generally comprises a block (or circuit) 102, a block (or circuit) 104, a block (or circuit) 106, a block (or circuit) 108, a plurality of blocks (or circuits) 110a-110n, a plurality of blocks (or circuits) 112a-112n and a plurality of blocks (or circuits) 114a-114n. The block 102 may be implemented as a data card module (or circuit). The circuit 104 may be implemented as a frequency generation circuit. The circuit 106 may be implemented as a control circuit. The circuit 108 may be implemented as multiplexer circuit. In one example, the circuit 108 may be implemented as a de-multiplexer circuit. The circuits 110a-110n may be implemented as frequency amplifier circuits. The circuits 112a-112n may be implemented as interface circuits. In one example, the circuits 112a-112n may be implemented as internal Media Access Control (MAC) interface circuits. The blocks 114a-114n may be implemented as a plurality of ports.

The system 100 may read data from the data card 102 (a single device) and provide connectivity to the ports 114a-114n (more than one device). The interfaces 112a-112n and ports 114a-n may be implemented as a variety of interface types. For example, a first interface type of the one or more ports 114a-114n may be a wireless interface/port. A second interface type of one or more of the ports 114a-114n may be a hard wired interface (e.g., an RJ45 port, fiberoptic port, or other type of hardwired port).

Alternately, one or more of the ports 112a-112n may be implemented as USB, PCMCIA, RJ45, RS232, Wireless Access Point, and/or other types of user interfaces. The system 100 may be implemented as a hardware device and/or a box comprising a pre-approved broadband data card 102 (e.g., Global System for Mobile Communications (GSM) card or Code Division Multiple Access (CDMA) card) from a particular carrier. Provisions may be implemented for changing a pre-approved card based on user preferences.

The system 100 may be implemented to provide multiple network/internet connections through a single USB broadband card 102. The connections may provide connectivity services to a variety of different user interfaces to allow time shared access with the single data card 102. For example, multiple users may use the system 100 to connect to the Internet without having to set up the typical infrastructure of configuring multiple devices.

The circuit 102 may present a signal (e.g., MUX) in response to a wireless signal (e.g., INPUT). The circuit 104 may present a signal (e.g., MUX_ADJ) in response to the signal MUX and a signal (e.g., CTR). The circuit 106 may present the signal CTR. The signal CTR may be a control signal configured to control the frequency of oscillation of the signal MUX_ADJ. The circuit 104 may generate a modified frequency for the signal MUX_ADJ. The circuit 106 may receive the signal MUX_ADJ and present a number of signals (e.g., INDa-INDn). The signals INDa-INDn may be individual signals related to a particular one of the ports 114a-114n.

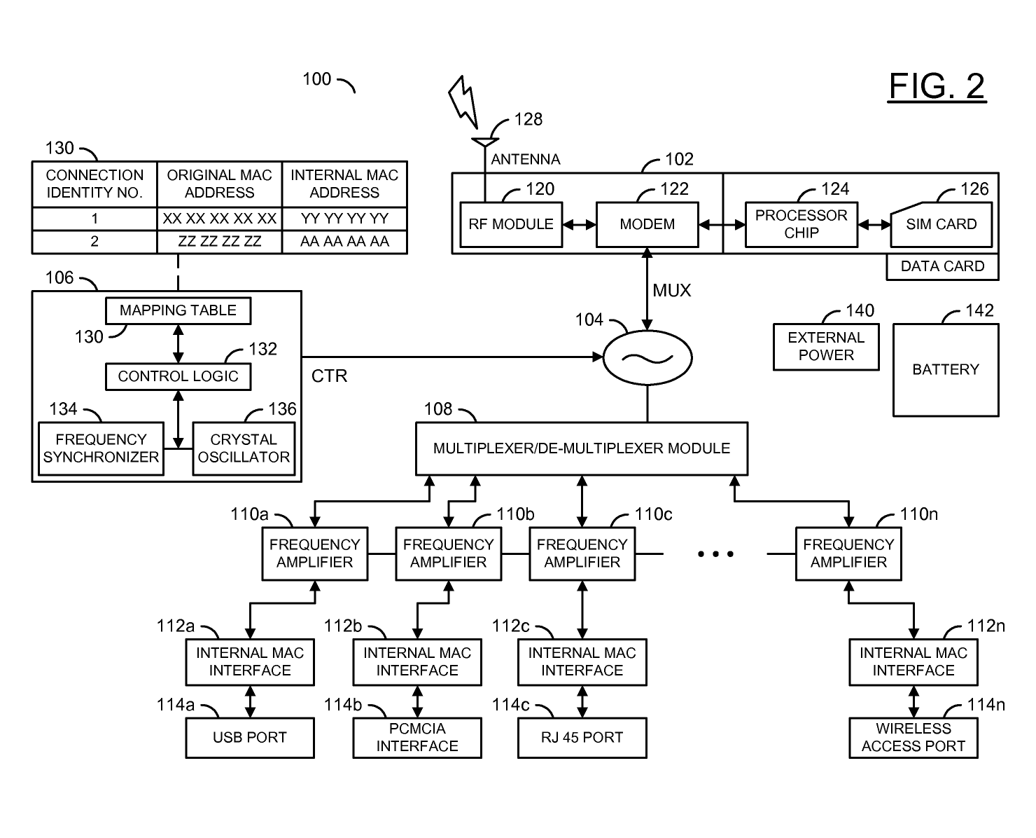

Referring to FIG. 2, a more detailed block diagram of the system 100 is shown. In one example, the data card module 102 may include a pre-approved USB broadband data card from a particular carrier. In one example, the data card module 102 may be implemented as a Global System for Mobile Communications (GSM) card. In another example, the data card module 102 may be implemented as a Code Division Multiple Access (CDMA) card. However, different types of data card module circuits 102 may be implemented to meet the design criteria of a particular implementation.

The data card module 102 generally comprises a block (or circuit) 120, a block (or circuit) 122, a block (or circuit) 124 and a block (or circuit) 126. The circuit 120 may be implemented as a Radio Frequency (RF) module. The circuit 122 may be implemented as a modem. The circuit 124 may be implemented as a processor circuit. The circuit 126 may be implemented as a Subscriber Identity Module (SIM) card. The module circuit 120 may connect to a network of a carrier through RF signals received via an antenna 128. The RF signals may be modulated and/or demodulated in the modem 122. The signal passing via the modem 122 may be transferred to the multiplexer and de-multiplexer module 108.

The control circuit 106 generally comprises a block (or circuit) 130, a block (or circuit) 132, a block (or circuit) 134 and a block (or circuit) 136. The circuit 130 may be implemented as a mapping table. The circuit 132 may be implemented as a control logic circuit. The circuit 134 may be implemented as a frequency synchronizer circuit. The circuit 136 may be implemented as a crystal oscillator circuit.

In one example, the table 130 may be implemented as a mapping table. The table 130 may comprise a number of MAC addresses corresponding to a connection identity number. The table 130 may comprise one or more connection identity numbers. In one example, the MAC addresses may be an original MAC address. In another example, the MAC addresses may be an internal MAC address.

The system 100 may receive power through an external power supply 140. However, the system 100 may also receive power through an onboard battery 142. The system 100 may implement a power saving mode. The hardware device 100 may also comprise the onboard battery 142. The battery 142 may allow the device 100 to operate in the absence of the external power supply 140 for a certain amount of time. Once the power supply 140 is connected, the regular operation may continue on external power. The battery 142 may be re-charged from the external power supply 140.

The system 100 may comprise an external power supply mode. When operating on external power, any channel connected to the ports 114a-114n may receive power from the power supply 140. The battery may be in a charging state during the external power supply mode. The system 100 may also comprise a battery power supply mode. When operating on battery power, any of the ports 114a-114n in a closed state may not receive any power. The battery 142 may receive power from any end user device connected to an open channel during the battery power supply mode.

In one example, the circuit 108 may be implemented as a multiplexer. In another example the circuit 108 may be implemented as a de-multiplexer. The module 108 may receive the signal MUX from the modem and create multiple data streams from the single signal by separating the signal into many segments. Each segment may comprise a very short duration. Each individual data stream may be passed on to different interfaces 112a-112n defined for the hardware device 100. The multiplexer 108 may combine the signals INDa-INDn received from the interfaces 112a-112n and convert the signals INDa-INDn into the signal MUX. The time duration for each interface 112a-112n may be defined based on priority of the interfaces 112a-112n provided by control logic 132.

The module 106 may control and/or oversee processes on the other hardware devices in the system 100. For example, the module 106 may control the circuit 108, the frequency synchronizer 134, and/or the crystal oscillator 136. The module 106 may detect and/or track a potential failure in a path to one of the ports 114a-114n and provide an alternate failover to a path to another one of the ports 114a-114n.

The control logic 132 may gather frequency information of the signal MUX from the modem 122. The control logic 132 may store the frequency information as a baseline value for the frequency synchronizer 134. Once the system 100 is powered up, the control logic 132 may extract the MAC information from the data card module 102. The control logic 132 may also define the internal MAC address for one or more of the respective ports 114a-114n. The control logic 132 may create the connection identity number and/or the port identity number (e.g., USB, RJ45, etc.). The control logic 132 may also map the actual MAC address of the data card module 102 to the internal MAC addresses on the ports 114a-114n and/or define the connection status on the ports 114a-114n (e.g., whether a port is in an open or closed state). All this information may be stored in the mapping table 130 as shown in TABLE 1:

TABLE 1

| Connection | Port(s) | MAC address | Internal MAC | Connection |
|---|---|---|---|---|
| Identity No. | Identity No. | of Device | address of port | status |
| 01 | 1 | 00-0C-F1-56-98-AD | 00-0C-F1-56-AA-AA | OPEN |
| 02 | 2 | 00-0C-F1-56-98-AD | 00-0C-F1-56-BB-BB | OPEN |
| 03 | 3 | 00-0C-F1-56-98-AD | 00-0C-F1-56-CC-CC | CLOSED |
| 04 | 4 | 00-0C-F1-56-98-AD | 00-0C-F1-56-DD-DD | OPEN |
| 05 | 5 | 00-0C-F1-56-98-AD | 00-0C-F1-56-EE-EE | OPEN |

The backend interfaces 112a-112n may comprise hard coded internal MAC addresses, the identity number of the ports 114a-114n and/or the connection identity number.

The signals INDa-INDn may become distorted after traversing through the multiplexer/de-multiplexer module 108. Therefore, the frequency synchronizer 134 may acquire a frequency reference level from the control logic 132. The frequency reference level may be compared with the signal MUX from the multiplexer/de-multiplexer 108. The comparison may be implemented using a checking function. Generally, the frequency of the signal MUX coming into the modem 122 is the same frequency as the signals INDa-INDn going into the interfaces 112a-112n. The checking function may check the comparison value.

The crystal oscillator 136 may generate a target frequency based on the signal CTR received from the control logic 132. The frequency generation circuit 104 may modify the incoming/outgoing signal to the multiplexer/de-multiplexer 108. If the incoming/outgoing signal MUX does not match the target value, then the frequency synchronizer 134 may ensure that signal strength is at a reference level defined by control logic 132. The frequency generation circuit 104 may increase the frequency on an as-needed basis in both the upstream and downstream cases.

The interfaces 112a-112n may be implemented as Internal MAC Interface (IMI) modules. The interfaces 112a-112n may define the internal MAC address for each of the ports 114a-114n. At power on, the control logic 132 may assign the internal MAC address to each of the interfaces 112a-112n. A channel or connection between the interfaces 112a-112n and the multiplexer/de-multiplexer 108 may be established. The control logic 132 may define the connection identity for the connection. The control logic 132 may store entries in the mapping table 130. The mapping table 130 and/or entries may be hard-coded into a software layer. Various signal/data stream(s) presented to the interfaces 112a-112n may be passed onto the multiplexer/de-multiplexer module 108. Each interface 112a-112n may also be used as a buffer to hold additional data stream(s) and/or to allow the ports 114a-114n to be serviced when the multiplexer/de-multiplexer 108 is busy processing other ports (if priority is defined) and/or stuck in a deadlock. The ports 114a-114n may be implemented as a USB port, PCMCIA, RJ 45 port, RS 232 Interface, a Wireless access point, and/or another user interface. The ports 114a-114n may connect to a PC and/or another end devices.

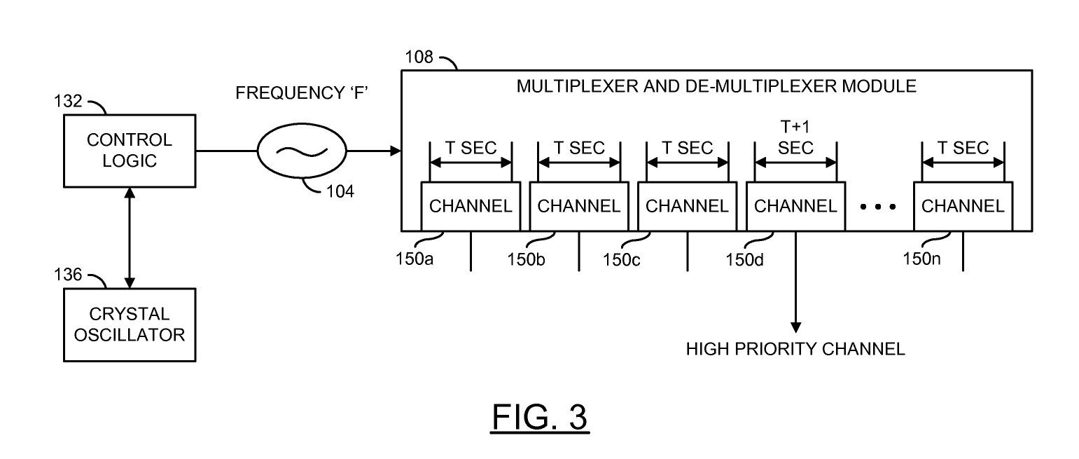

Referring to FIG. 3, a diagram illustrating assignment of priority to multiple channels 150a-150n is shown. The multiplexer/de-multiplexer 108 may comprise the channels 150a-150n. Based on the user input, the priority of a particular channel may be defined. If an end device connected to a channel (e.g., the channel 150d), a corresponding one of the interfaces 112a-112n may need to transfer/receive high priority data. The control logic 132 in the control circuit 106 may assign a high priority to that particular channel. Priority may be achieved by manipulating the frequency of oscillation received from the crystal oscillator 136 by increasing or decreasing the time period “T”. By allowing an increased time period, an end device (e.g., a personal computer connected to one of the ports 114a-114n) may transfer the data for a longer period of time.

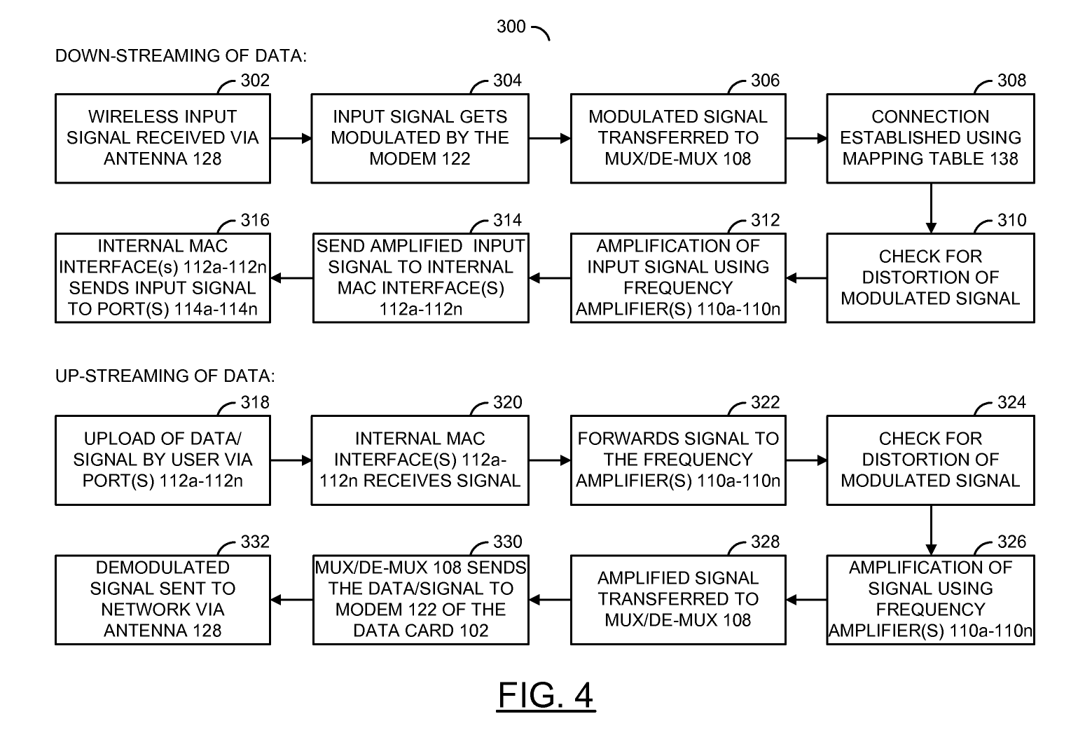

Referring to FIG. 4, a diagram illustrating a process (or method) 300 for upstream and downstream data flow is shown. Communication flow in the method 300 may be implemented downstream and/or upstream. The method 300 generally comprises a step (or state) 302, a step (or state) 304, a step (or state) 306, a step (or state) 308, a step (or state) 310, a step (or state) 312, a step (or state) 314, a step (or state) 316, a step (or state) 318, a step (or state) 320, a step (or state) 322, a step (or state) 324, a step (or state) 326, a step (or state) 328, a step (or state) 330 and a step (or state) 332.

The steps 302-316 may comprise down-streaming of data. In the step 302, the method 300 may receive a wireless input signal (e.g., INPUT) via the antenna 128. Next, in the state 304, the method 300 may modulate the input signal via the modem 122. Next, in the state 306, the method 300 may transfer the modulated signal to the mux/de-mux circuit 108. Next, in the state 308, the method 300 may establish a connection using the mapping table 130. Next, in the state 310, the method 300 may check for distortion of the modulated signal. Next, in the state 312, the method 300 may amplify the input signal using the frequency amplifiers 110a-110n. Next, in the state 314, the method 300 may send the amplified signal to the internal MAC interfaces 112a-112n. Next, in the state 316, the method 300 may send the input signal from the internal MAC interfaces 112a-112n to the ports 114a-114n.

The steps 318-332 may comprise up-streaming of data. In the step 318, the method 300 may upload a signal from a user via the ports 112a-112n. Next, in the state 320, the internal MAC interfaces 112a-112n may receive the signal. Next, in the state 322, the method 300 may forward the signals to the frequency amplifiers 110a-110n. Next, in the state 324, the method 300 may check for distortion of the modulated signal. Next, in the state 326, the method 300 may amplify the signal using the frequency amplifiers 110a-110n. Next, in the state 328, the method 300 may transfer the amplified signal to the mux/de-mux circuit 108. Next, in the state 330, the method 300 may send the signal from the mux/de-mux circuit 108 to the modem 122 in the data card 102. Next, in the state 332, the method 300 may send the demodulated signal to the network via the antenna 128.

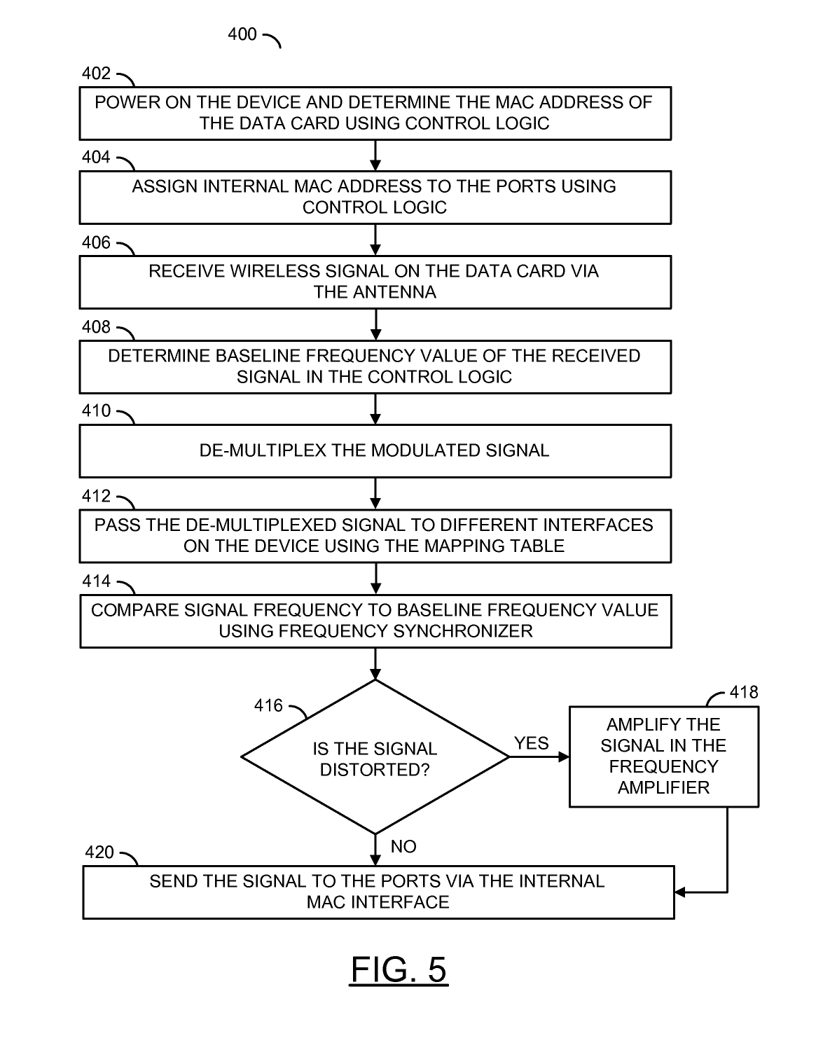

Referring to FIG. 5, a diagram of a method (or process) 400 is shown. The method 400 illustrates the process of down streaming the signals from the network using the hardware device 100. The method 400 generally comprises a step (or state) 402, a step (or state) 404, a step (or state) 406, a step (or state) 408, a step (or state) 410, a step (or state) 412, a step (or state) 414, a decision step (or state) 416, a step (or state) 418 and a step (or state) 420.

In the step 402, the method 400 may provide power for the device 100 and determine the map address of the data card module using the control logic 132. Next, in the state 404, the method 400 may assign an internal MAC address to the ports 114a-114n using the control logic 132. Next, in the state 406, the method 400 may receive a wireless signal (e.g., INPUT) on the data card 102 via the antenna 128. Next, in the state 408, the method 400 may determine a baseline frequency value of the receipt signal in the control logic 132. Next, in the state 410, the method 400 may de-multiplex the modulated signal MUX. Next, in the state 412, the method 400 may pass the de-multiplex signal INDa-INDn to the interfaces 112a-112n using the mapping table 130. Next, in the state 414, the method 400 may compare a signal frequency baseline to a baseline frequency value using the frequency synchronizer 134. Next, in the state 416, the method 400 may determine if the signal MUX_ADJ or the signals INDa-INDn are distorted. If so, the method 400 moves to the state 418. If not, the method 400 moves to the state 420. In the state 418, the method 400 may amplify the signal using the frequency amplifiers 110a-110n. In the state 420, the method 400 may send the signal to the ports 114a-114n through the internal MAC interfaces 112a-112n.

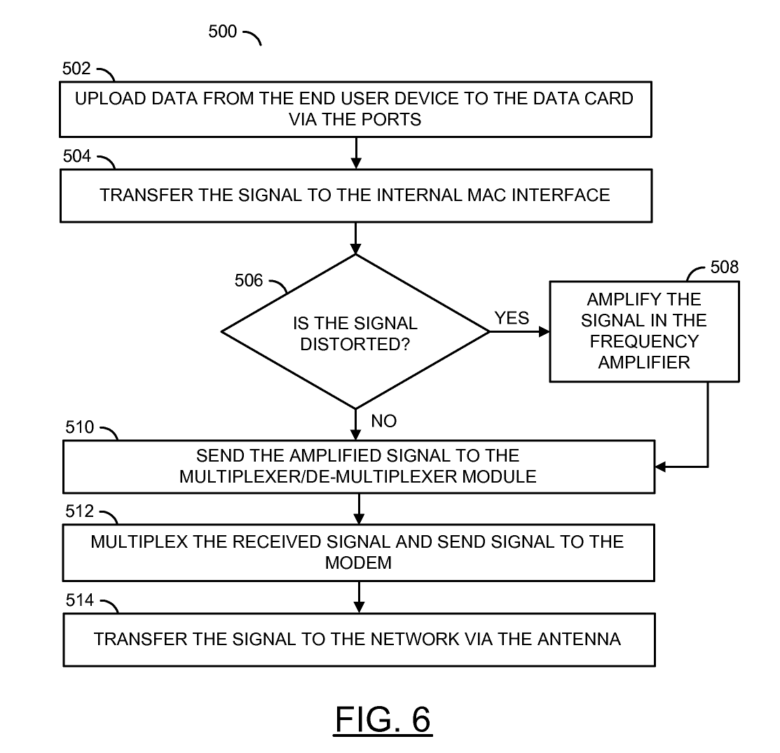

Referring to FIG. 6, a diagram illustrating a method (or process) 500 is shown. The method 500 illustrates the process of up streaming data from a end user device (e.g., a personal computer) into the network using the hardware device 100. The method 500 generally comprises a step (or state) 502, a step (or state) 504, a decision step (or state) 506, a step (or state) 508, a step (or state) 510, a step (or state) 512 and a step (or state) 514.

In the state 502, the method 500 may upload data from an end user device to the data card 102 via the ports 114a-114n. In the state 504, the method 500 may transfer the signal to the internal MAC interfaces 112a-112n. Next, in the state 506, the method 500 may determine if the signal is distorted. If so, the method 500 moves to the state 508. If not, the method 500 moves to the state 510. In the state 510, the signal may be amplified with the frequency amplifiers 110a-110n. In the state 510, the method 500 may send the amplified signal to the multiplexer/de-multiplexer module 108. Next, in the state 512, the method 500 may multiplex the received signal and send the signal to the modem 122. Next, in the state 514, the method 500 may transfer the signal to a network via the antenna 128.

The bandwidth received on the wireless signal INPUT may be shared across the number of devices connected to the ports 114a-114n. The system 100 may be implemented in environments where multiple users need access to the Internet/network without a setup environment.

The system 100 may comprise a USB broadband card that may interface with the connected user device (e.g., computer) using a Universal Serial Bus (USB) connector. The system 100 may allow multiple users having different connection interfaces (e.g., USB, PCMCIA, RJ45, RS232, or a Wireless router Access Point) to access a broadband network through the single data card module 102. The data card module 102 may be compatible with GSM, CDMA, or other protocols. The device 100 may allow multiple users to obtain connectivity via a single data card. The device 100 may implement internal channels and/or mapping tables to route data to the respective interfaces 112a-112n controlled by control logic 106. The control logic 106 may manipulate data transfer rates by increasing the time duration per channel to service enhanced data transfer for that end device based on priority. The device 102 may operate using the battery 142 in the absence of the external power supply 140. The device 102 may also implement various power saving modes while operating on either external power supply or battery power. Portable working stations may be created to provide instant internet access to users without having to set up the infrastructure typically associated with such plans.

The functions performed by the diagrams of FIGS. 4, 5 and 6 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the present specification, as will be apparent to those skilled in the relevant art(s). Appropriate software, firmware, coding, routines, instructions, opcodes, microcode, and/or program modules may readily be prepared by skilled programmers based on the teachings of the present disclosure, as will also be apparent to those skilled in the relevant art(s). The software is generally executed from a medium or several media by one or more of the processors of the machine implementation.

The present invention may also be implemented by the preparation of ASICs (application specific integrated circuits), Platform ASICs, FPGAs (field programmable gate arrays), PLDs (programmable logic devices), CPLDs (complex programmable logic device), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The present invention thus may also include a computer product which may be a storage medium or media and/or a transmission medium or media including instructions which may be used to program a machine to perform one or more processes or methods in accordance with the present invention. Execution of instructions contained in the computer product by the machine, along with operations of surrounding circuitry, may transform input data into one or more files on the storage medium and/or one or more output signals representative of a physical object or substance, such as an audio and/or visual depiction. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (electronically programmable ROMs), EEPROMs (electronically erasable ROMs), UVPROM (ultra-violet erasable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, storage and/or playback devices, video recording, storage and/or playback devices, game platforms, peripherals and/or multi-chip modules. Those skilled in the relevant art(s) would understand that the elements of the invention may be implemented in other types of devices to meet the criteria of a particular application.

While the invention has been particularly shown and described with reference to the preferred embodiments thereof, it will be understood by those skilled in the art that various changes in form and details may be made without departing from the scope of the invention.

1. An apparatus comprising:
a device configured to present/receive a multiplexed data signal from a wireless network;
a multiplexer circuit configured to present/receive a plurality of data signals in response to said multiplexed data signal; and
a plurality of interface circuits comprising at least one of a first interface type and a second interface type, each interface circuit configured to present/receive a respective one of said data signals, wherein said apparatus allows said plurality of interface circuits to share access to said wireless network.

2. The apparatus according to claim 1, wherein one of said interface circuits is configured to provide connectivity to said wireless network.

3. The apparatus according to claim 2, wherein said connectivity to said wireless network is configured to operate on a plurality of cellular systems.

4. The apparatus according to claim 1, further comprising a plurality of ports, a respective one of said ports connected to a respective one of said interfaces.

5. The apparatus according to claim 1, wherein one of said interface circuits comprises a RJ-45 port.

6. The apparatus according to claim 1, wherein one of said interface circuits comprises a USB port.

7. The apparatus according to claim 1, further comprising a frequency amplifier configured to amplify a frequency of said multiplexed data signal in response to a control signal.

8. The apparatus according to claim 7, wherein said frequency amplifier amplifies a selected one of said data signals in response to a bandwidth request from a respective one of said interface circuits.

9. The apparatus according to claim 1, Wherein said device further comprises a card slot configured to accept a removable storage device.

10. An apparatus comprising:
means for presenting/receiving a multiplexed data signal from a wireless network;
means for presenting/receiving a plurality of data signals in response to said multiplexed data signal; and
means for interfacing between at least one of a first interface type and a second interface type, said interfacing to present/receive a respective one of said data signals, wherein said apparatus allows a plurality of interface circuits to share access to said wireless network.

11. A method for sharing an internet connection comprising the steps of:
(A) presenting/receiving a multiplexed data signal from a wireless network;
(B) presenting/receiving a plurality of data signals in response to said multiplexed data signal; and
(C) interfacing between at least one of a first interface type and a second interface type, said interfacing to present/receive a respective one of said data signals, wherein said apparatus allows a plurality of interface circuits to share access to said wireless network.

12. The method according to claim 12, further comprising the step of:
determining if one or more of said data signals are distorted; and
amplifying one or more of said data signals.
